(19) United States
(12) Patent Application Publication
(10) Pub. No.: US 2016/0106296 A1
(43) Pub. Date: Apr. 21, 2016

(54) FILTER MODULE WITH END CAPS INCLUDING INTEGRAL VALVES

(71) Applicant: Dow Global Technologies LLC, Midland, MI (US)

(72) Inventors: Jie Cai, Shanghai (CN); Bin Chen, Shanghai (CN); Liangzhou Fan, Huzhou (CN); Yongjin Guo, Shanghai (CN); Chengfeng Wang, Huzhou (CN)

(73) Assignee: Dow Global Technologies LLC, Midland, MI (US)

(21) Appl. No.: 14/783,211

(22) PCT Filed: Jun. 9, 2013
(86) PCT No.: PCT/CN2013/077049

§ 371 Date: Oct. 8, 2015

(51) Int. Cl. A47L 15/42; B01D 65/02; B01D 63/04

(52) U.S. Cl. CPC A47L 15/4208; A47L 15/4206; B01D 63/04; B01D 65/02; B01D 2313/18; B01D 2313/26; B01D 2319/04; B01D 2321/185

(57) ABSTRACT

Provided is a filter module which includes: i) an elongated housing extending along an axis between a first and second end and defining an inner chamber; ii) a plurality of hollow fiber membranes comprising a semi-permeable cylindrical wall enclosing a lumen, wherein the membranes extend axially within the inner chamber between the first and second end; iii) a first end cap assembly comprising: a base secured to the first end of the housing, a feed port defining a passageway in fluid communication with the inner chamber, and a gas port adapted for connection to a source of pressurized gas and defining a passageway in fluid communication with the inner chamber; and iv) a second end cap assembly comprising: a base secured to the second end of the housing, a permeate port defining a passageway in fluid communication the lumens of the hollow fiber membranes, and a purge port defining a passageway in fluid communication with the inner chamber. The first end cap assembly includes an integral valve for controlling fluid flow through at least one of the gas port and feed port, and the second end cap assembly includes an integral valve for controlling fluid flow through at least one of the permeate port and purge port.

### FIELD

The invention is directed toward membrane-based filter modules and washing assemblies.

### BACKGROUND

Filter modules including hollow fiber semi-permeable membranes are used in a wide variety of applications ranging from industrial processing of liquids to residential purification of drinking water. Such modules typically include a tubular-shaped housing defining an inner chamber with one or more fluid ports located near each end of the housing. In operation, feed fluid enters the module via a port and passes through a semi-permeable membrane located within the inner chamber. Fluid passing through the membrane exits the module by way of a permeate port, often located at the opposite end of the module. Filter modules may also include additional fluid ports or channels including inlets for introducing liquid or gas for cleaning the module. Examples of such modules include DOW™ Ultrafiltration module models: SFP-2860, SFP-2880, SFD-2860 and SFD-2880 available from The Dow Chemical Corporation. These filter modules include semi-permeable hollow fiber membranes design for ultrafiltration-type applications such as the treatment of water. The above-mentioned modules include fluid ports that are molded as an integral part of an end cap assembly mounted on each end of the module housing. See for example U.S. Pat. No. 8,261,919.

### SUMMARY

The invention is directed toward filter modules and associated component parts along with methods for making and using the same including their incorporation into washing assemblies. The filter module includes: i) an elongated housing extending along an axis between a first and second end and defining an inner chamber; ii) a plurality of hollow fiber membranes comprising a semi-permeable cylindrical wall enclosing a lumen, wherein the membranes extend axially within the inner chamber between the first and second end; iii) a first end cap assembly comprising: a base secured to the first end of the housing, a feed port defining a passageway in fluid communication with the inner chamber, and a gas port adapted for connection to a source of pressurized gas and defining a passageway in fluid communication with the inner chamber; and iv) a second end cap assembly comprising: a base secured to the second end of the housing, a permeate port defining a passageway in fluid communication with the lumens of the hollow fiber membranes, and a purge port defining a passageway in fluid communication with the inner chamber. The first end cap assembly includes an integral valve for controlling fluid flow through at least one of the gas port and feed port, and the second end cap assembly includes an integral valve for controlling fluid flow through at least one of the permeate port and purge port.

### BRIEF DESCRIPTION OF THE DRAWINGS

Figures are provided to facilitate description and are not necessarily to scale. Where possible, like reference numerals are used throughout the figures to refer to like elements.

FIG. 1 is an exploded perspective view, partially cut-away, of one embodiment of the subject filter module showing the housing and first and second end cap assemblies.

FIG. 2a is a perspective view, partially cut-away and in phantom, of one embodiment of the first end cap assembly showing fluid flow pathways associated with one valve position.

FIG. 2b is a view of the embodiment of FIG. 2a showing fluid flow pathways associated with an alternative valve position.

FIG. 2c is a view of the embodiment of FIG. 2a showing fluid flow pathways associated with another alternative valve position.

FIG. 2d is a view of the embodiment of FIG. 2a showing fluid flow pathways associated with yet another alternative valve position.

FIG. 2e is a perspective view, partially cut-away and in phantom, of another embodiment of the first end cap assembly showing fluid flow pathways associated with one valve position.

FIG. 3a is a perspective view of a portion of the module with showing the base of the second end cap assembly showing in FIG. 1, in accordance with the first end cap assembly of FIG. 2e.

FIG. 3b is a perspective view of the embodiment of FIG. 3a showing the cap (in phantom) and the base of the second end cap assembly.

FIG. 3c is another perspective view of the embodiment of the second end cap assembly showing in FIGS. 1 and 3b.

FIG. 3d is a schematic view of the second end assembly showing various ports and flow passageways.

FIG. 4 is a schematic view of an embodiment of the invention including the subject filter module as a component of a washing assembly.

### DETAILED DESCRIPTION

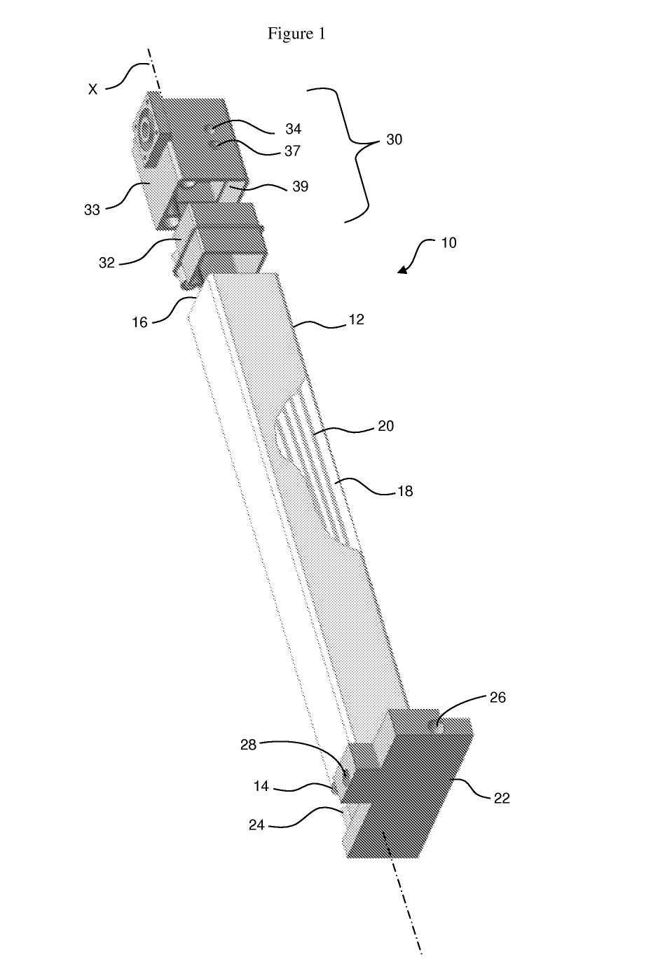

An embodiment of the subject filter module is generally shown at 10 in FIG. 1 including an elongated housing (12) extending along an axis (X) between a first (14) and second (16) end and defining an inner chamber (18). While shown as having a rectangular cross-section, the housing (12) may have an alternative configuration, e.g. elliptical (e.g. cylindrical shape with a circular cross-section) or polygonal cross-section. The housing (12) may be constructed from a wide variety of materials, e.g. plastics, ceramics, metals, etc., however, in one set of preferred embodiments the housing is made from an injection moldable plastic such as polyvinyl chloride (PVC) or acrylonitrile butadiene styrene (ABS).

A plurality of hollow fiber membranes (20) extend axially along the inner chamber (18) between the first (14) and second (16) ends of the housing (12). The membranes (20) comprise a semi-permeable cylindrical wall enclosing a lumen. Applicable semi-permeable membranes are not limited and include those made from various materials including: ceramics, polysulfones, polyether sulfones, polyvinylidene fluoride, polyamides, polyacrylonitrile and polyolefins. The average pore size of the hollow fiber membranes is preferably selected to suit the end use of the module, e.g. to remove debris such as food, grease, proteins, oils and the like, e.g. average pore sizes in the microfiltration range (i.e. 0.1 to 5 micron). In a preferred embodiment, the average pore size of the membrane is in ultrafiltration range, (i.e. 0.01 to 0.10 micron) such that protozoa, bacteria and viruses are at least partially removed.

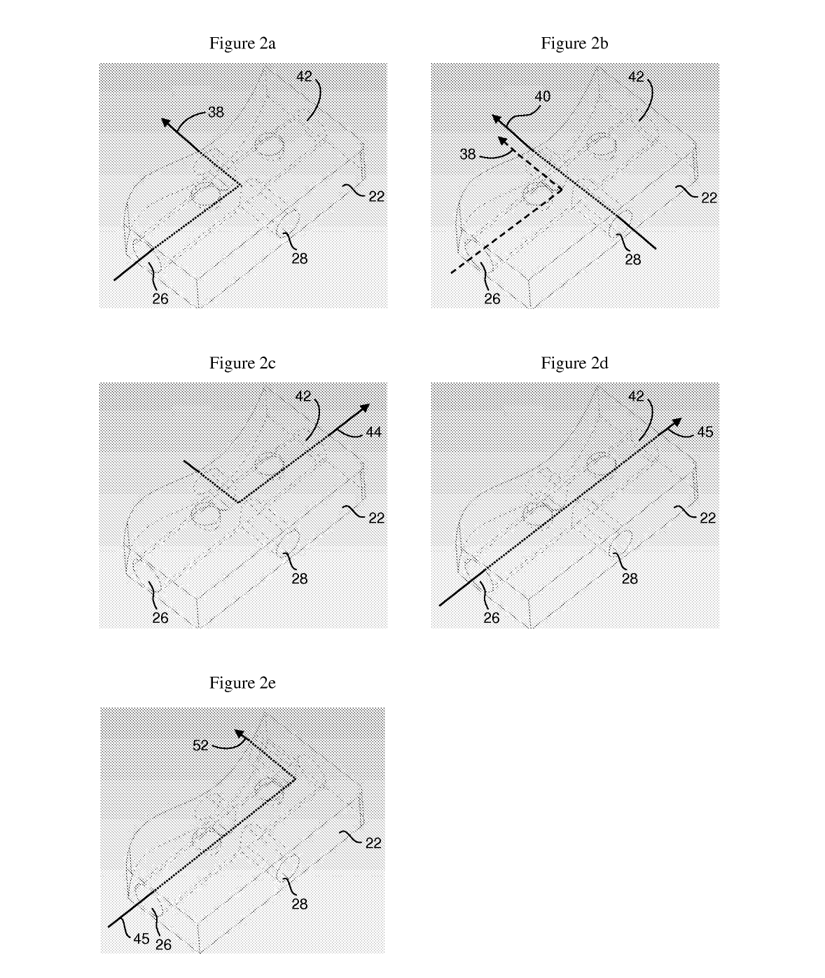

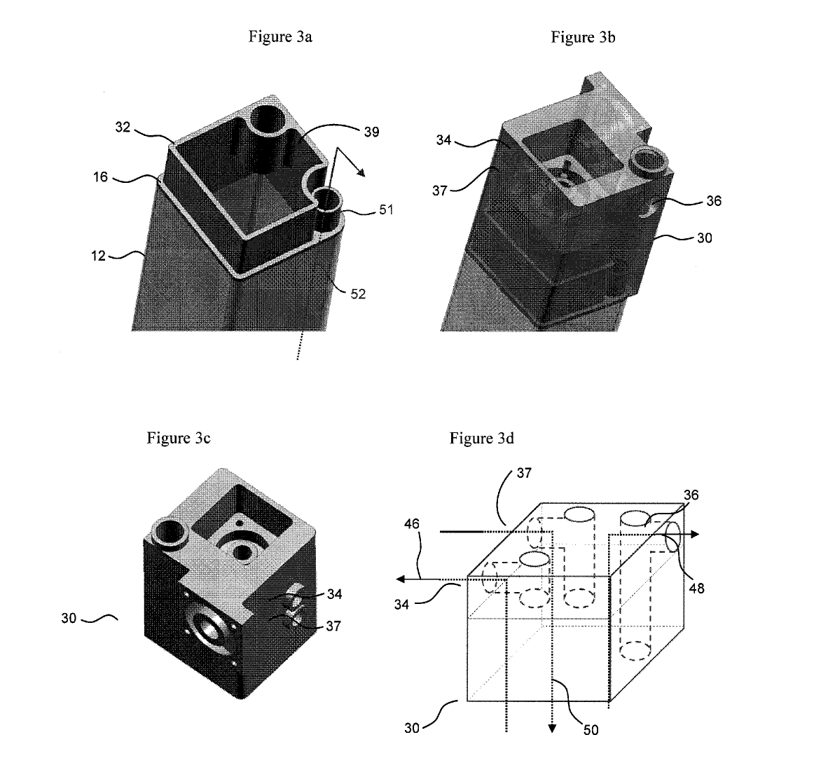

The module (10) includes a first end cap assembly (22) including: a base (24) secured to the first end (14) of the housing (12), a feed port (26) defining a passageway in fluid communication with the inner chamber (18), a gas port (28) adapted for connection to a source of pressurized gas and defining a passageway in fluid communication with the inner chamber (18) and an optional drain port (42, shown in FIG. 2). A second end cap assembly (30) including a base (32) is secured to the second end (16) of the housing (12). The second end cap assembly includes a permeate port (34) defining a passageway in fluid communication with the lumens of the hollow fiber membranes (20), a purge port (36—shown in FIG. 3b) defining a passageway in fluid communication with the inner chamber (18) and an optional fresh liquid port (37) which may be used for backwashing the module (10). As illustrated, the second end cap assembly (30) includes a two piece assembly including the base (32) and a cap (33) which are secured together during installation. In an alternative embodiment, a single piece construction may be used, e.g. a single molded unit. The end cap assemblies (22, 30) may be constructed from a wide variety of materials, e.g. plastics, ceramics, metals, etc., however, in a preferred set of embodiments the assemblies are made from an injection moldable plastic such as polyvinyl chloride (PVC) or acrylonitrile butadiene styrene (ABS). The end cap assemblies (22, 30) may include additional fluid ports of various orientations.

The bases (24, 32) of the end cap assemblies (22, 30) may be disposed about or within the respective first and second ends (14, 16) of the housing (12). In preferred embodiments the outer periphery of the base of the end cap assembly includes a matching or complementary configuration with that of the inner periphery of the end of the housing such that the base can be slid, tightly fitted and preferably sealed about or within the end of the housing (12). Depending upon the materials of construction, the base may be secured to the housing (12) via mechanical means, e.g. pressure fit, clamps, matching threads, etc., or may be adhered such as by way of ultrasonic welding, spin welding, adhesive, etc., or combinations of such techniques.

The ends of the hollow fiber membranes (20) may be sealed from the inner chamber (18) by way of known “potting” techniques wherein one or both ends of the hollow fibers membranes (20) remain open and in fluid communication with one or more outer chambers formed within the end cap assemblies (22, 30). See for example US 2012/0074054. In a preferred embodiment, the ends of hollow fibers membranes (20) are sealed within the first end cap assembly (22) but remain open in fluid communication with a chamber (39) within the second end cap assembly (30) but are otherwise sealed from the inner chamber (18) by potting material (e.g. epoxy, urethane, silicone, etc.).

During standard operation, pressurized feed liquid enters the module (10) by way of the feed port (26) and flows into the inner chamber (18) where a portion of the feed liquid passes through semi-permeable membranes (20) thereby becoming “filtrate,” which in turn travels to a chamber (39) within the second end cap assembly (30) where it ultimately exits the module (10) by way of the permeate port (34). When operating in conventional cross-flow mode, the remaining feed liquid may exit the module (10) by way of a purge port (36). When operating in conventional dead-end mode, the residual feed liquid may be intermittently purged or drained from the module (10) through the purge or drain ports (36, 42) which are more fully described below.

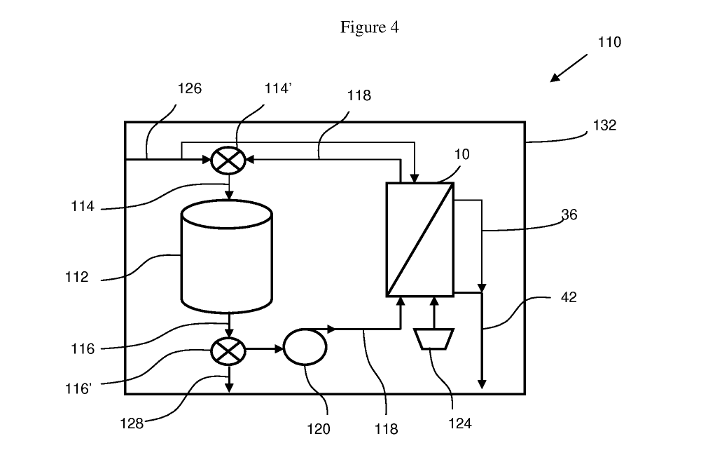

In one embodiment, the module (10) may be cleaned by opening the gas port (28) and purge port (36), and closing the permeate port (34). An aerator (best shown in FIG. 4) introduces pressurized gas (e.g. air) into gas port (28) which travels through the inner chamber (18) and exits the module by way of the purge port (36). Gas bubbles passing through the inner chamber (18) effectively dislodge debris that may have accumulated on the outer surfaces of the membranes (20). The accumulated debris may be jettison from the inner chamber (18) by way of the purge port (36) or may be subsequently drained by opening an optional drain port (42, shown in FIG. 2) in the first end cap assembly (22).

In another embodiment, the module (10) may be backwashed by opening the drain port (42) and the fresh liquid port (37). The fresh liquid port (37) is adapted for connection to a source of pressurized fresh liquid which flows into chamber (39), the lumens of the membranes (20) and through the semi-permeable walls of the membranes (20) where it enters the inner chamber (18), and finally exits the module (10) by way of the drain port (42). During backwashing, the other ports are preferably closed. In another embodiment, the module (10) may be backwashed by opening the purge port (36) and the fresh liquid port (37).

As will be further explained, fluid flow through the various ports during operation may be controlled by valves. While valves may be actuated manually, they are preferably electro magnetically controlled by way of a PLC such that valve actuation is synchronized. As will be described in more detail in connection with the other Figures, the first end cap assembly (22) includes an integral valve for controlling fluid flow through at least one and preferably both the feed port (26) and the gas port (28) along with any optional drain port (42). Similarly, the second end cap assembly (30) includes an integral valve for controlling fluid flow through at least one and preferably both the permeate port (34) and the purge port (36). In a preferred embodiment, the first end cap assembly (22) includes an integral valve for controlling fluid flow through the gas port (28) and the second end cap assembly includes an integral valve for controlling fluid flow through the purge port (36). In another preferred embodiment, the first and second end cap assemblies (22, 30) both include at least two integral valves for controlling fluid flow through ports. In another preferred embodiment, the first and second end cap assemblies (22, 30) include integral valves for controlling fluid flow through all ports. In yet another embodiment, the actuation of the integral valve of the first end cap assembly (22) is synchronized with the actuation of the integral valve of the second end cap assembly (30). As used herein, the term “integral valve” means that the valve forms a part of the end cap assembly, i.e. is secured to or within the assembly.

An embodiment of the first end cap assembly (22) is shown in various modes of operation in FIGS. 2a, 2b, 2c and 2d. The first end cap assembly (22) includes a feed port (26) defining a passageway (38) in fluid communication with the inner chamber (shown in FIG. 1), and a gas port (28) adapted for connection to a source of pressurized gas (e.g. an aerator as shown in FIG. 4) and defining a passageway (40) in fluid communication with the inner chamber. An optional drain port (42) is also provided. FIG. 2a illustrates the first end cap assembly (22) operating in standard operating mode with feed liquid entering the feed port (26) and passing along passageway (38) into the inner chamber of the housing. FIG. 2b illustrates the first end cap assembly (22) operating in a cleaning mode with pressurized gas entering the gas port (28) and passing along passageway (40) into the inner chamber. As indicated by a dashed arrow (38) in FIG. 2b, feed liquid may simultaneously pass into the inner chamber with gas, or may be discontinued by closing a valve. FIG. 2c illustrates an optional draining mode of operation wherein liquid is drained from the inner chamber along a passageway (44) through a drain port (42). When operating in the draining mode, the gas and feed ports (28, 26) are preferably closed. FIG. 2d illustrates a bypass mode where feed liquid passes along a passageway (45) through the end cap assembly (22) by entry through the feed port (26) and exit by way of the drain port (42). Another embodiment is shown in FIG. 2e. When operating in the drain mode or in the bypass mode, liquid passes along the passageway (44 or 45), goes into a passageway (52) and exits by way of the purge port (36). A part of the passageway (52) is within a chamber (51, shown in FIG. 3a) extending along with the inner chamber (18).

Flow of fluid through the various ports is controlled by one or more valves. In a preferred embodiment, one or more valves are integrated into the first end cap assembly (22). For example, in a preferred embodiment, a valve controlling fluid flow through the gas port (28) is located along the passageway (40). In an alternative embodiment, valves controlling one or both of the feed and drain ports (26, 42) may also be integral within the first end cap assembly (22). In yet another embodiment, multiple valves may be replaced with a multi-way valve for simultaneously controlling fluid flow of multiple passageways (e.g. 38, 40, 44, and 45).

An embodiment of the second end cap assembly (30) is shown in FIGS. 3a, 3b, 3c and 3d. As shown, the second end cap assembly (30) includes a base (32) secured to the second end (16) of the housing (12), a permeate port (34) defining a passageway (46) in fluid communication with the lumens of the hollow fiber membranes (20), a purge port (36) defining a passageway (48) in fluid communication with the inner chamber (18) and an optional fresh liquid port (37) defining a passageway (50) in fluid communication with the chamber (39) and the lumens of the hollow fiber membranes (20). The second end cap assembly (30) includes an integral valve for controlling fluid flow through at least one, two or all ports (34, 36, 37) and corresponding passageways (46, 48, 50). Multiple valves may be replaced with a multi-way valve for simultaneously controlling fluid flow of multiple passageways.

As mentioned previously, the aforementioned integral valves are preferably electromagnetically actuated and controlled by a PLC such that their actuation can be synchronized during various modes of operation. For example, during standard operating mode, the feed port (26) and permeate port (34) are open and all other ports may be closed. During cleaning mode, the permeate port (34), fresh liquid port (37), and optionally feed port (26) are closed and the gas and purge ports (28, 36), and optionally drain port (42) are open for aeration; the permeate port (34) and the fresh liquid port (37) are closed, and the feed port (26), the purge port (36), and optionally the drain port (42) and the gas port (28) are open for flushing. During backwash mode, the fresh liquid port (37), the drain port (42), and optionally purge port (36) are open and all other ports are closed. Many additional modes and variances from the described modes may be used.

While described as operating “outside-in” mode (i.e. feed liquid contacting the outside of the hollow fiber membranes), the module may alternatively be operated in “inside-out” mode wherein feed fluid is introduced inside the lumen portion of the hollow fibers. While feed fluid is typically introduced into the module under pressure, the module may alternatively be operated by applying negative pressure to the permeate side of the semi-permeable membrane, or a combination of both positive and negative pressure.

In another embodiment of the invention, one or more of the previously described filter modules (10) are provided as a component of a washing assembly including the following components: i) a wash tub, ii) a water inlet and waste water outlet in fluid communication with the wash tub, iii) a fluid pathway extending from the waste water outlet to the water inlet, iv) a pump for moving water along the fluid pathway, v) a filter module located along the fluid pathway, and vi) an aerator in fluid communication with the filter module. As used herein, the term “washing assembly” refers to tub or basin along with a source of water or cleaning fluid and a drain for removing used or “waste” water. The term “ware” refers to items such as glassware (e.g. bottles), tableware, flatware (e.g. cutlery, utensils), dishware (e.g. dishes), cookware, (e.g. pots, pans) and other items for use with food and beverages during their preparation, storage or consumption. The term “laundry” refers to items made from textiles or fabrics including items such as clothing and linens (e.g. tablecloths, bedding, towels, etc.). In one embodiment, the invention includes a washing machine designed to clean ware items. In another embodiment, the invention includes a washing machine designed to clean laundry items. In yet another embodiment, the invention includes a personal bathing assembly, e.g. tub or shower. Machines for cleaning laundry and ware items are well known in the art. A typical washing machine includes a wash tub and an electrically operated pump which are housed in a cabinet. The tub is accessible by way of a sealable door. During a typical wash cycle, water and detergent are combined and manipulated about the wash tub during a washing stage, after which time the resulting waste water is discharged. The tub is subsequently refilled with fresh feed water in one or more rinse stages. The repetitive filling and draining of the wash tub takes time and uses a large quantity of water.

A schematic view of a generic embodiment of the invention is provided in FIG. 4 wherein a washing assembly (e.g. washing machine) is generally shown at 110 including a wash tub (112) adapted to temporarily house items to be cleaned. While not particularly limited, the wash tub (112) preferably includes a sealable door that provides convenient access to an inner chamber. In an embodiment designed to clean ware items, the wash tub (112) may include shelves and compartments for securing ware items during cleaning. In an embodiment designed to clean laundry, the wash tub (112) may include cylindrical drum which is capable of spinning about an axis. The wash tub (112) is in fluid communication with at least one water inlet (114) and a waste water outlet (116). The water inlet (114) is adapted to provide a route for liquid to flow into the wash tub (112) while the waste water outlet (116) provides a route for waste water to flow out of the tub (112). The inlet (114) and outlet (116) may include or be connected to valves (114′, 116′) that selectively control ingress and egress of liquid into and out of the tub (112). For purposes of this description, the term “waste water” refers to water that has been used to either wash or rinse items within the tub (112). A fluid pathway (118) comprising one or more pipes extending from the waste water outlet (116) to the water inlet (114). A pump (120) provides a driving force for moving water along the fluid pathway (118). As will be described below, one or more pumps may be utilized.

A filter module (10) as previously described is located along the fluid pathway (118). While shown as a single unit, multiple filter modules may be used in a parallel of serial arrangement.

The washing machine (110) further includes an aerator (124) in fluid communication with the filter module (10). The aerator provides a source of gas bubbles (e.g. air bubbles) to the inner chamber of the filter module which remove debris from the surface of membrane. In one embodiment, the aerator comprises one or more gas nozzles in fluid communication with a source of gas such as ambient air. Gas pressure may be generated by an independent pump or gas blower (not shown). While not shown, the aerator may also be in direct fluid communication with the wash tub (112) to provide gas bubbles to the tub during cleaning or rinse stages.

The washing machine includes a feed water inlet (126) adapted for connection to a source of water (e.g. tap water), a drain port (42) adapted to an external drain, and optionally a waste discharge port (128) adapted for connection to an external drain. Each port may include a valve which may be selectively opened or closed during operation.

In a preferred embodiment the aforementioned components of washing machine (110) are integrally housed within a cabinet (132). In a preferred commercial embodiment, the filter module (10) is relatively small in size as compared with the washing machine, e.g. the volume ratio of the filter module (10) to the cabinet (132) is preferably from 1:20 to 1:1000.

The preferred method of cleaning includes a wash cycle comprising at least one wash stage followed by at least one and preferably two rinse stages. The method is characterized by at least one stage reusing water from a preceding stage or the same stage that has passed through the filter module (10). Wash stages are characterized by the combination of water with a detergent or other cleaning composition whereas rinse stages generally include no detergent (although anti-scalants may be used). That is, in a preferred embodiment, the wash cycle comprises at least one wash stage comprising the introduction of water and a detergent into the wash tub followed by at least one rinse stage wherein waste water which has passed through the filter module is reintroduced into the wash tub without adding detergent.

In operation, items to be cleaned are positioned within the wash tub (112) and feed water selectively enters the wash tub (112) by way the feed water inlet (126). Automated valves and a pump may facilitate this process so that an optimized water level is achieved. Detergent or other cleaning compounds may also be provided and the resulting wash water is sprayed, agitated or otherwise manipulated about the tub (112) to remove debris from the items. Thereafter, i.e. typically 10 to 30 minutes, the wash stage ends and the resulting waste water is drained from the tub (112) by way of the waste water outlet (116). Once again, automated valves and the pump (120) may facilitate this process. The waste water may be removed from the washing machine (110) by opening waste discharge port (128), or the waste water (or portion thereof) may be recycled by passing through the filter module (10).

After the wash stage one or more rinse stages are initiated. Water comprising feed water from the feed water inlet (126) or permeate passing through the membrane of the filter module (10), or a combination of both water sources is used as rinse water and is introduced into the wash tub (112) through water inlet (114). A preferred mix ratio is at least 3:1 permeate to fresh feed water. When operated in cross-flow mode, concentrated waste water unable to pass through the membranes may be discharged by way of the drain port (42) and/or the purge port (36). When operating in dead end flow mode, debris is collected within the module (10) may be removed in a manner as previously described. In a preferred embodiment, waste water from the wash stage is disposed of via the waste discharge port (128) or optionally the drain port (42), but waste water from the first rinse stage is recycled through the filter module (10) and reused.

As previously described, the semi-permeable membranes may be cleaned by introducing gas bubbles into the filter module (10) by way of the aerator (124). Bubbles flow upward through the module (10) and dislodge debris that collects upon the surface of the membrane. The bubbles may then selectively exit the module (10) by way of the purge port (36). Additionally, feed water may be periodically back-flushed through the membrane and removed from the module (10) by way of the drain port (42) and/or the purge port (36). Aeration may be conducted after a wash or rinse stage, or may be continuous throughout one or more stages. Similarly, filtration of waste water may occur continuously through a wash or rinse stages, or be conducted off-line and stored within an interior or exterior holding tank for use in subsequent wash or rinse stage. In a preferred embodiment, filtration occurs continuously during the first rinse stage. Integrated circuitry or similar means may be used to control stage timing and value actuation during the cycle.

In addition to wash and rinse stages, integrated circuitry may be suitable to implement a separate cleaning stage. In this cleaning stage, aeration may be performed without permeation through the module (10). Alternatively, the cleaning stage may also include aeration and/or backwash (reverse permeation from normal operation) and/or forward wash (flushing) from through the module (10). For instance, this may be implemented by redirecting a valve to provide pressurized water from the feed water port (126), the wash tub (112) or pump (210) to the module's inner chamber. This cleaning stage may include continuous or batch removal of debris from the module (10) through the drain port (42) and/or the purge port (36). The cycle time for the cleaning stage may be longer than for either the wash or rinse stages.

Many embodiments of the invention have been described and in some instances certain embodiments, selections, ranges, constituents, or other features have been characterized as being “preferred”. The designation of a feature as being “preferred” should not be interpreted as deeming such features as an essential or critical aspect of the invention.

What is claimed is:

1. A filter module (10) comprising:
i) an elongated housing (12) extending along an axis (X) between a first (14) and second (16) end and defining an inner chamber (18),
ii) a plurality of hollow fiber membranes (20) comprising a semi-permeable cylindrical wall enclosing a lumen, wherein the membranes extend axially within the inner chamber (18) between the first (14) and second (16) end,
iii) a first end cap assembly (22) comprising:
a base (24) secured to the first end (14) of the housing (12),
a feed port (26) defining a passageway in fluid communication with the inner chamber (18),
and a gas port (28) adapted for connection to a source of pressurized gas and defining a passageway in fluid communication with the inner chamber (18),
iv) a second end cap assembly (30) comprising:
a base (32) secured to the second end (16) of the housing (12),
a permeate port (34) defining a passageway in fluid communication the lumens of the hollow fiber membranes (20), and
a purge port (36) defining a passageway in fluid communication with the inner chamber (18);
wherein the module (10) is characterized by the first end cap assembly (22) including an integral valve (38) for controlling fluid flow through at least one of the gas port (28) and feed port (26), and the second end cap assembly (30) including an integral valve (40) for controlling fluid flow through at least one of the permeate port (34) and purge port (36).

2. The module of claim 1 wherein the first end cap assembly includes an integral valve for controlling fluid flow through the gas port (28) and the second end cap assembly includes an integral valve for controlling fluid flow through the purge port (36).

3. The module of claim 1 wherein the first and second end cap assemblies (22, 30) both include at least two integral valves for controlling fluid flow through ports.

4. The module of claim 1 wherein the first and second end cap assemblies (22, 30) include integral valves for controlling fluid flow through all ports.

5. The module of claim 1 wherein actuation of the valve of the first end cap assembly (22) is synchronized with the valve of the second end cap assembly (30).

6. A washing assembly (110) comprising the following components: i) a wash tub (112), ii) a water inlet (114) and waste water outlet (116) in fluid communication with the wash tub (112), iii) a fluid pathway (118) extending from the waste water outlet (116) to the water inlet (114), iv) a pump (120) for moving water along the fluid pathway (118), v) a filter module (10) as set forth in claim 1 located along the fluid pathway (118), and vi) an aerator (124) in fluid communication with the filter module (10).

7. The washing assembly (110) of claim 6 for washing ware items wherein each component is housed within a common cabinet (132).
